(19) United States
(12) Patent Application Publication
(10) Pub. No.: US 2025/0165853 A1
(43) Pub. Date: May 22, 2025

(54) SYSTEM AND METHOD FOR IDENTIFYING WHEN TO RETRAIN AN ARTIFICIAL INTELLIGENCE MODEL

(71) Applicant: JPMorgan Chase Bank, N.A., New York, NY (US)

(72) Inventors: Saumitra MISHRA, London (GB); Emanuele ALBINI, London (GB); Minhaj KHAN, London (GB); Daniele MAGAZZENI, London (GB); Manuela VELOSO, New York, NY (US); Barney O'KANE, Darien, CT (US)

(73) Assignee: JPMorgan Chase Bank, N.A., New York, NY (US)

(21) Appl. No.: 18/514,481

(22) Filed: Nov. 20, 2023

(51) Int. Cl. G06N 20/00

(52) U.S. Cl. CPC G06N 20/00

(57) ABSTRACT

Various methods and processes, apparatuses/systems, and media for identifying when to retrain an AI model are disclosed. A processor receives the AI model and a set of target data samples on a predefined time period; implements an artificial intelligence technique to generate a plurality of counterfactuals and corresponding target data samples among the set of target data samples for analyzing performance of the received AI model; computes an average counterfactual distance between closest counterfactuals and corresponding target data samples on the predefined time period; compares the average counterfactual distance to a predefined threshold value; identifies that the AI model needs to be retrained when output data from comparing indicates that the average counterfactual distance is less than the predefined threshold value; and automatically retrains the AI model when it is determined that the average counterfactual distance is less than the predefined threshold value.

### TECHNICAL FIELD

This disclosure generally relates to data processing and artificial intelligence (AI) model, and, more particularly, to methods and apparatuses for implementing a platform, language, cloud, and database agnostic AI model analyzing module for identifying when to retrain an AI model.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Today, a wide variety of business functions are commonly supported by software applications and tools, i.e., business intelligence (BI) tools, Artificial Intelligence (AI) tools, AI models, etc. For instance, an AI model trained using samples with distribution training data is deployed in production where it daily receives a set of target samples for which it predicts labels/scores. It is expected that the distribution of target samples data to be similar to training samples data and this may ensure that the AI model will perform well (e.g., accurately classify target samples).

However, in reality, the predictive performance of the AI model fluctuates over time—especially, performing poorly when training and target distributions differ (i.e., distribution of target samples data is not similar to training samples data). Identifying when the model is performing poorly may prove to be critical as this may help to develop a model retraining schedule. However, often, due to absent or delayed ground-truth labels for target samples data, analyzing model performance using standard metrics (e.g., F1-score) is not available.

Conventionally, the problem of unsupervised model performance analysis has been studied in many different ways. An exemplary first category of approaches may be referred to as “proxy approaches” which may analyze how the distance between the training and target set feature distributions changes over time. The hypothesis is that if the two distributions differ significantly, then the model performance on the target set would be poor than on the training set. The second category of approaches may work for models that assign confidence scores (e.g., prediction probabilities) to its predictions. These approaches analyze how the distance between the distribution of model confidence scores for training and target set samples changes over time. Both categories of approaches may work well in certain scenarios, but several challenges remain. For example, the proxy approaches result in high number of false positives. Similarly, the second category of approaches may require the models to be well-calibrated and provide confidence scores, both of which may not be readily available.

Thus, there is a need for an advance tool and methodology that can address these conventional shortcomings corresponding to identifying when to retrain an AI model.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic AI model analyzing module for automatically and dynamically identifying when to retrain an AI model, but the disclosure is not limited thereto. For example, the platform, language, cloud, and database agnostic AI model analyzing module may utilize/implement both input samples and how an AI model reacts to them, thereby by producing robust insights into how an AI model is performing, eventually leading to less false positives (i.e., training a model when the performance did not degrade enough) than the conventional approaches mentioned above, but the disclosure is not limited thereto.

According to exemplary embodiments, a method for identifying when to retrain an AI model by utilizing one or more processors along with allocated memory is disclosed. The method may include: receiving an AI model and a set of target data samples on a predefined time period (i.e., a predefined day) for identifying when to retrain the AI model; implementing an artificial intelligence technique to generate a plurality of counterfactuals and corresponding target data samples among the set of target data samples for analyzing performance of the received AI model; computing an average counterfactual distance between closest counterfactuals and corresponding target data samples on the predefined time period; comparing the average counterfactual distance to a predefined threshold value; identifying that the AI model needs to be retrained when output data from comparing indicates that the average counterfactual distance is less than the predefined threshold value; and automatically retraining the AI model when it is determined that the average counterfactual distance is less than the predefined threshold value.

According to exemplary embodiments, the plurality of counterfactuals may be plausible samples on a desired side of a decision boundary generated by perturbing a query sample.

According to exemplary embodiments, the predefined threshold value may be use case or dataset specific and may be used to identify whether retraining of the AI model is needed or not.

According to exemplary embodiments, the method may further include: displaying how the counterfactual distance evolves over time on a two-dimensional graph wherein x-axis of the graph represents days (i.e., time period) and y-axis of the graph represents average counterfactual distance.

According to exemplary embodiments, the method may further include: analyzing how the average counterfactual distance evolves over time by monitoring the graph.

According to exemplary embodiments, the method may further include: determining that the AI model is less confident in outputting a prediction data based on determining that the target data samples are getting close to the decision boundary over time (i.e., the average counterfactual distance is reducing consistently).

According to exemplary embodiments, the method may further include: identifying that the AI model does not need to be retrained when output data from comparing indicates that the average counterfactual distance is equal to or more than the predefined threshold value.

According to exemplary embodiments, a system for identifying when to retrain an AI model is disclosed. The system may include: a processor; and a memory operatively connected to the processor via a communication interface, the memory storing computer readable instructions, when executed, may cause the processor to: receive an AI model and a set of target data samples on a predefined time period (i.e., a predefined day) for identifying when to retrain the AI model; implement an artificial intelligence technique to generate a plurality of counterfactuals and corresponding target data samples among the set of target data samples for analyzing performance of the received AI model; compute an average counterfactual distance between closest counterfactuals and corresponding target data samples on the predefined time period; compare the average counterfactual distance to a predefined threshold value; identify that the AI model needs to be retrained when output data from comparing indicates that the average counterfactual distance is less than the predefined threshold value; and automatically retrain the AI model when it is determined that the average counterfactual distance is less than the predefined threshold value.

According to exemplary embodiments, the processor may be further configured to: display how the counterfactual distance evolves over time on a two-dimensional graph wherein x-axis of the graph represents days (i.e., predefined time period) and y-axis of the graph represents average counterfactual distance.

According to exemplary embodiments, the processor may be further configured to: analyze how the average counterfactual distance evolves over time by monitoring the graph.

According to exemplary embodiments, the processor may be further configured to: determine that the AI model is less confident in outputting a prediction data based on determining that the target data samples are getting close to the decision boundary over time (i.e., the average counterfactual distance is reducing consistently).

According to exemplary embodiments, the processor may be further configured to: identify that the AI model does not need to be retrained when output data from comparing indicates that the average counterfactual distance is equal to or more than the predefined threshold value.

According to exemplary embodiments, a non-transitory computer readable medium configured to store instructions for identifying when to retrain an AI model is disclosed. The instructions, when executed, may cause a processor to perform the following: receiving an AI model and a set of target data samples on a predefined time period (i.e., a predefined day) for identifying when to retrain the AI model; implementing an artificial intelligence technique to generate a plurality of counterfactuals and corresponding target data samples among the set of target data samples for analyzing performance of the received AI model; computing an average counterfactual distance between closest counterfactuals and corresponding target data samples on the predefined time period; comparing the average counterfactual distance to a predefined threshold value; identifying that the AI model needs to be retrained when output data from comparing indicates that the average counterfactual distance is less than the predefined threshold value; and automatically retraining the AI model when it is determined that the average counterfactual distance is less than the predefined threshold value.

According to exemplary embodiments, the plurality of counterfactuals may be plausible samples on a desired side of a decision boundary generated by perturbing a query sample and the predefined threshold value may be use case or dataset specific and may be used to identify whether retraining of the AI model is needed or not, and the instructions, when executed, may cause the processor to further perform the following: displaying how the counterfactual distance evolves over time on a two-dimensional graph wherein x-axis of the graph represents days (i.e., predefined time period) and y-axis of the graph represents average counterfactual distance.

According to exemplary embodiments, the instructions, when executed, may cause the processor to further perform the following: analyzing how the average counterfactual distance evolves over time by monitoring the graph.

According to exemplary embodiments, the instructions, when executed, may cause the processor to further perform the following: determining that the AT model is less confident in outputting a prediction data based on determining that the target data samples are getting close to the decision boundary over time (i.e., the average counterfactual distance is reducing consistently).

According to exemplary embodiments, the instructions, when executed, may cause the processor to further perform the following: identifying that the AI model does not need to be retrained when output data from comparing indicates that the average counterfactual distance is equal to or more than the predefined threshold value.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic AI model analyzing module configured for identifying when to retrain an AI model in accordance with an exemplary embodiment.

FIG. 2 illustrates an exemplary diagram of a network environment with a platform, language, database, and cloud agnostic AI model analyzing device in accordance with an exemplary embodiment.

FIG. 3 illustrates a system diagram for implementing a platform, language, database, and cloud agnostic AI model analyzing device having a platform, language, database, and cloud agnostic AI model analyzing module in accordance with an exemplary embodiment.

FIG. 4 illustrates a system diagram for implementing a platform, language, database, and cloud agnostic AI model analyzing module of FIG. 3 in accordance with an exemplary embodiment.

FIG. 5 illustrates an exemplary graph implemented by the platform, language, database, and cloud agnostic AI model analyzing module of FIG. 4 for displaying a query sample and its two counterfactuals in a feature space of a binary classifier in accordance with an exemplary embodiment.

FIG. 6 illustrates another exemplary graph implemented by the platform, language, database, and cloud agnostic AI model analyzing module of FIG. 4 for illustrating how the counterfactual distance evolves over time in identifying when to retrain an AI model in accordance with an exemplary embodiment.

FIG. 7 illustrates an exemplary flow chart of a process implemented by the platform, language, database, and cloud agnostic AI model analyzing module of FIG. 4 for identifying when to retrain an AI model in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

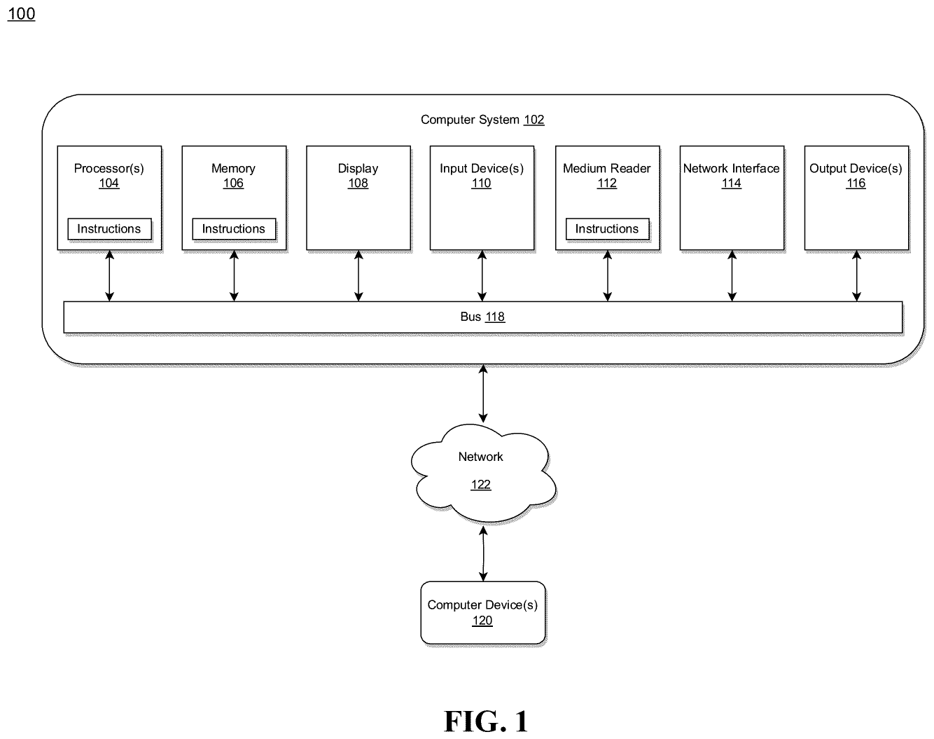

FIG. 1 is an exemplary system 100 for use in implementing a platform, language, database, and cloud agnostic AI model analyzing module configured to automatically and dynamically identifying and determining when to retrain an AI model in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the AI model analyzing module implemented by the system 100 may be platform, language, database, and cloud agnostic that may allow for consistent easy orchestration and passing of data through various components to output a desired result regardless of platform, browser, language, database, and cloud environment. Since the disclosed process, according to exemplary embodiments, is platform, language, database, browser, and cloud agnostic, the AI model analyzing module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

The present disclosure, through one or more of its various aspects, embodiments, and/or specific features or sub-components, provides within system 100, among other features, various systems, servers, devices, methods, media, programs, and platforms for implementing a platform, language, cloud, and database agnostic AI model analyzing module for automatically and dynamically identifying and determining when to retrain an AI model, but the disclosure is not limited thereto.

For example, the present disclosure, through one or more of its various aspects, embodiments, and/or specific features or sub-components, also provides within system 100, among other features, various systems, servers, devices, methods, media, programs, and platforms for implementing a platform, language, cloud, and database agnostic AI model analyzing module that utilizes/implements both input samples and how an AI model reacts to them, thereby by producing robust insights into how an AI model is performing, eventually leading to less false positives (i.e., training a model when the performance did not degrade enough) than the conventional approaches mentioned above, but the disclosure is not limited thereto.

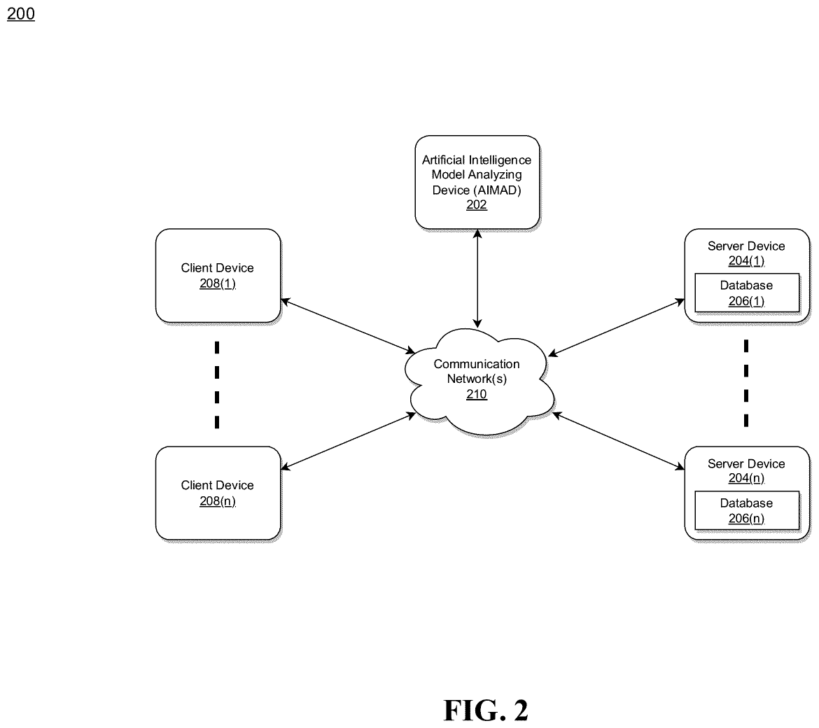

Referring to FIG. 2, a schematic of an exemplary network environment 200 for implementing a language, platform, database, and cloud agnostic AI model analyzing device (AIMAD) of the instant disclosure is illustrated.

According to exemplary embodiments, the above-described problems associated with conventional tools may be overcome by implementing an AIMAD 202 as illustrated in FIG. 2 that may be configured for implementing a platform, language, database, and cloud agnostic AI model analyzing module configured to systemically and dynamically identifying and determining when to retrain an AI model, but the disclosure is not limited thereto. For example, according to exemplary embodiments, the above-described problems associated with conventional tools may be overcome by implementing an AIMAD 202 as illustrated in FIG. 2 that may be configured for implementing a platform, language, database, and cloud agnostic AI model analyzing module configured to systemically and dynamically utilize/implement both input samples and how an AI model reacts to them, thereby by producing robust insights into how an AI model is performing, eventually leading to less false positives (i.e., training a model when the performance did not degrade enough) than the conventional approaches mentioned above

The AIMAD 202 may have one or more computer system 102s, as described with respect to FIG. 1, which in aggregate provide the necessary functions.

The AIMAD 202 may store one or more applications that can include executable instructions that, when executed by the AIMAD 202, cause the AIMAD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AIMAD 202 itself, may be located in virtual server(s) running in a cloud-based computing environment rather than being tied to one or more specific physical network computing devices. Also, the application(s) may be running in one or more virtual machines (VMs) executing on the AIMAD 202. Additionally, in one or more embodiments of this technology, virtual machine(s) running on the AIMAD 202 may be managed or supervised by a hypervisor.

In the network environment 200 of FIG. 2, the AIMAD 202 is coupled to a plurality of server devices 204(1)-204(n) that hosts a plurality of databases 206(1)-206(n), and also to a plurality of client devices 208(1)-208(n) via communication network(s) 210. A communication interface of the AIMAD 202, such as the network interface 114 of the computer system 102 of FIG. 1, operatively couples and communicates between the AIMAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AIMAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AIMAD 202 may be a standalone device or integrated with one or more other devices or apparatuses, such as one or more of the server devices 204(1)-204(n), for example. In one particular example, the AIMAD 202 may be hosted by one of the server devices 204(1)-204(n), and other arrangements are also possible. Moreover, one or more of the devices of the AIMAD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AIMAD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the AIMAD 202 that may efficiently provide a platform for implementing a platform, language, database, and cloud agnostic AI model analyzing module configured to automatically and dynamically identifying and determining when to retrain an AI model, but the disclosure is not limited thereto. For example, according to exemplary embodiments, the above-described problems associated with conventional tools may be overcome by implementing an AIMAD 202 as illustrated in FIG. 2 that may be configured for implementing a platform, language, database, and cloud agnostic AI model analyzing module configured to systemically and dynamically utilize/implement both input samples and how an AI model reacts to them, thereby by producing robust insights into how an AI model is performing, eventually leading to less false positives (i.e., training a model when the performance did not degrade enough) than the conventional approaches mentioned above, but the disclosure is not limited thereto.

The client devices 208(1)-208(n) may run interface applications, such as standard web browsers or standalone client applications, which may provide an interface to communicate with the AIMAD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the AIMAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the AIMAD 202, the server devices 204(1)-204(n), or the client devices 208(1)-208(n), for example, may be configured to operate as virtual instances on the same physical machine. For example, one or more of the AIMAD 202, the server devices 204(1)-204(n), or the client devices 208(1)-208(n) may operate on the same physical device rather than as separate devices communicating through communication network(s) 210. Additionally, there may be more or fewer AIMADs 202, server devices 204(1)-204(n), or client devices 208(1)-208(n) than illustrated in FIG. 2. According to exemplary embodiments, the AIMAD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

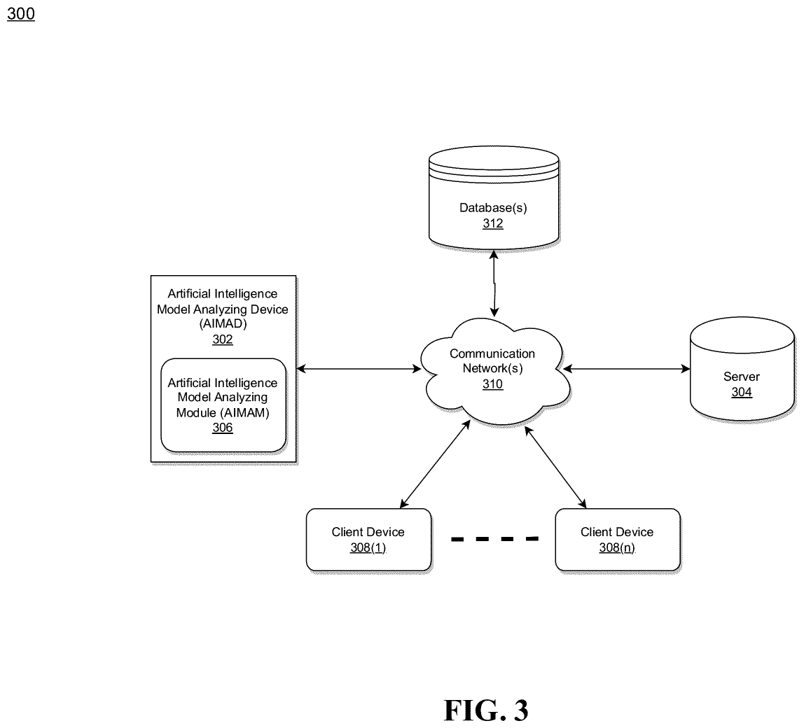

FIG. 3 illustrates a system diagram for implementing a platform, language, and cloud agnostic AIMAD having a platform, language, database, and cloud agnostic AI model analyzing module (AIMAM) in accordance with an exemplary embodiment.

As illustrated in FIG. 3, the system 300 may include an AIMAD 302 within which an AIMAM 306 is embedded, a server 304, a database(s) 312, a plurality of client devices 308(1) . . . 308(n), and a communication network 310.

According to exemplary embodiments, the AIMAD 302 including the AIMAM 306 may be connected to the server 304, and the database(s) 312 via the communication network 310. The AIMAD 302 may also be connected to the plurality of client devices 308(1) . . . 308(n) via the communication network 310, but the disclosure is not limited thereto.

According to exemplary embodiment, the AIMAD 302 is described and shown in FIG. 3 as including the AIMAM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

According to exemplary embodiments, the AIMAM 306 may be configured to receive real-time feed of data from the plurality of client devices 308(1) . . . 308(n) and secondary sources via the communication network 310.

As may be described below, the AIMAM 306 may be configured to: receive an AI model and a set of target data samples on a predefined time period (i.e., a predefined day) for identifying when to retrain the AI model; implement an artificial intelligence technique to generate a plurality of counterfactuals and corresponding target data samples among the set of target data samples for analyzing performance of the received AI model; compute an average counterfactual distance between closest counterfactuals and corresponding target data samples on the predefined time period; compare the average counterfactual distance to a predefined threshold value; identify that the AI model needs to be retrained when output data from comparing indicates that the average counterfactual distance is less than the predefined threshold value; and automatically retrain the AI model when it is determined that the average counterfactual distance is less than the predefined threshold value, but the disclosure is not limited thereto.

The plurality of client devices 308(1) . . . 308(n) are illustrated as being in communication with the AIMAD 302. In this regard, the plurality of client devices 308(1) . . . 308(n) may be “clients” (e.g., customers) of the AIMAD 302 and are described herein as such. Nevertheless, it is to be known and understood that the plurality of client devices 308(1) . . . 308(n) need not necessarily be “clients” of the AIMAD 302, or any entity described in association therewith herein. Any additional or alternative relationship may exist between either or both of the plurality of client devices 308(1) . . . 308(n) and the AIMAD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the AIMAD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The AIMAD 302 may be the same or similar to the AIMAD 202 as described with respect to FIG. 2, including any features or combination of features described with respect thereto.

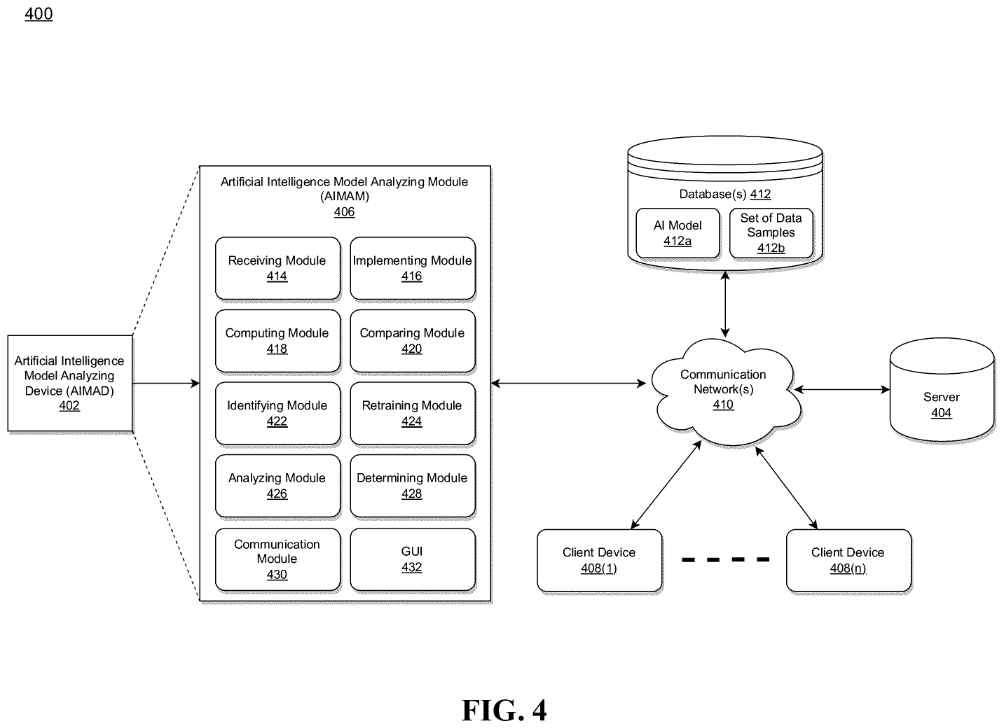

FIG. 4 illustrates a system diagram for implementing a platform, language, database, and cloud agnostic AIMAM of FIG. 3 in accordance with an exemplary embodiment.

According to exemplary embodiments, the system 400 may include a platform, language, database, and cloud agnostic AIMAD 402 within which a platform, language, database, and cloud agnostic AIMAM 406 is embedded, a server 404, database(s) 412, and a communication network 410. According to exemplary embodiments, server 404 may comprise a plurality of servers located centrally or located in different locations, but the disclosure is not limited thereto. The database(s) may store an AI model 412a and a set of target data samples 412b.

According to exemplary embodiments, the AIMAD 402 including the AIMAM 406 may be connected to the server 404, and the database(s) 412 via the communication network 410. The AIMAD 402 may also be connected to the plurality of client devices 408(1)-408(n) via the communication network 410, but the disclosure is not limited thereto. The AIMAM 406, the server 404, the plurality of client devices 408(1)-408(n), the database(s) 412, the communication network 410 as illustrated in FIG. 4 may be the same or similar to the AIMAM 306, the server 304, the plurality of client devices 308(1)-308(n), the database(s) 312, the communication network 310, respectively, as illustrated in FIG. 3.

According to exemplary embodiments, the present disclosure, through one or more of its various aspects, embodiments, and/or specific features or sub-components, provides, among other features, various systems, servers, devices, methods, media, programs, and platforms for implementing the platform, language, cloud, and database agnostic AIMAM 406 to systemically and dynamically identifying and determining when to retrain an AI model, but the disclosure is not limited thereto. For example, the AIMAM 406 may utilize both input samples and how an AI model reacts to them, thereby by producing robust insights into how an AI model is performing, eventually leading to less false positives (i.e., training a model when the performance did not degrade enough) than the conventional approaches mentioned above, but the disclosure is not limited thereto.

According to exemplary embodiments, the data generated by the inventive concepts implemented by the AIMAM 406 as disclosed herein can be shared with other downstream applications via API or data share algorithms for analytics and artificial intelligence and business intelligence dashboards according to consumer work-load needs.

Details of the AIMAM 406 is provided below with corresponding modules.

According to exemplary embodiments, as illustrated in FIG. 4, the AIMAM 406 may include a receiving module 414, an implementing module 416, a computing module 418, a comparing module 420, an identifying module 422, a retraining module 424, an analyzing module 426, a determining module 426, a communication module 428, and a GUI 430. According to exemplary embodiments, interactions and data exchange among these modules included in the AIMAM 406 provide the advantageous effects of the disclosed invention. Functionalities of each module of FIG. 4 may be described in detail below with reference to FIGS. 4-6.

According to exemplary embodiments, each of the receiving module 414, implementing module 416, computing module 418, comparing module 420, identifying module 422, retraining module 424, analyzing module 426, determining module 426, and the communication module 428 of the AIMAM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the receiving module 414, implementing module 416, computing module 418, comparing module 420, identifying module 422, retraining module 424, analyzing module 426, determining module 426, and the communication module 428 of the AIMAM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the receiving module 414, implementing module 416, computing module 418, comparing module 420, identifying module 422, retraining module 424, analyzing module 426, determining module 426, and the communication module 428 of the AIMAM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the AIMAM 406 of FIG. 4 may also be implemented by Cloud based deployment.

According to exemplary embodiments, each of the receiving module 414, implementing module 416, computing module 418, comparing module 420, identifying module 422, retraining module 424, analyzing module 426, determining module 426, and the communication module 428 of the AIMAM 406 of FIG. 4 may be called via corresponding API, but the disclosure is not limited thereto. For example, calls may also be made using event-based message interfaces in addition to APIs.

According to exemplary embodiments, the process implemented by the AIMAM 406 may be executed via the communication module 428 and the communication network 410, which may comprise plural networks as described above. For example, in an exemplary embodiment, the various components of the AIMAM 406 may communicate with the server 404, and the database(s) 412 via the communication module 428 and the communication network 410 and the results may be displayed onto the GUI 430. Of course, these embodiments are merely exemplary and are not limiting or exhaustive. The database(s) 412 may include the databases included within the private cloud and/or public cloud and the server 404 may include one or more servers within the private cloud and the public cloud.

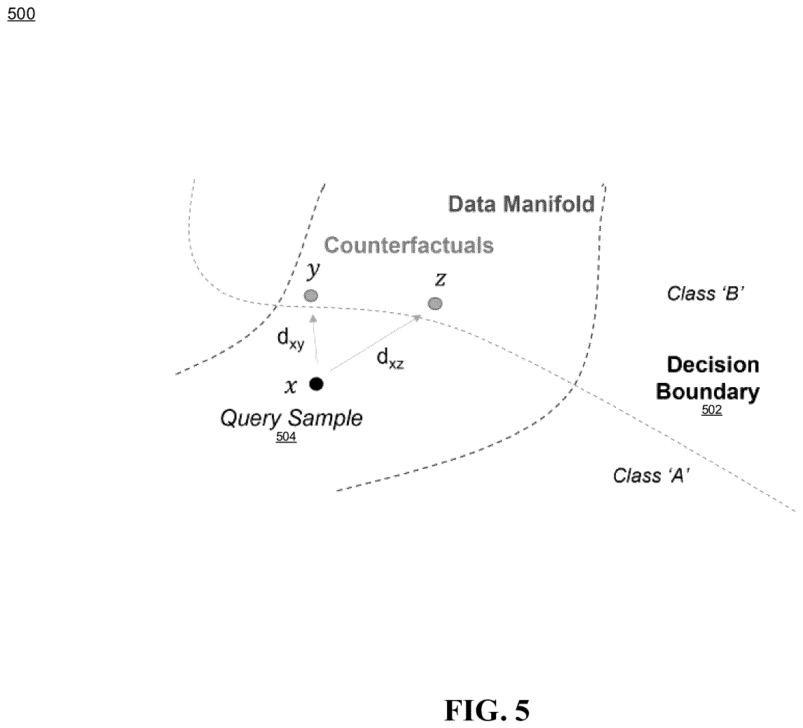

FIG. 5 illustrates an exemplary graph 500 implemented by the platform, language, database, and cloud agnostic AIMAM 406 of FIG. 4 for displaying a query sample 504 (i.e., x in FIG. 5) and its two counterfactuals (i.e., y and z in FIG. 5) in a feature space of a binary classifier in accordance with an exemplary embodiment.

For example, as illustrated in FIG. 5, the AIMAM 406 implements a methodology that leverages an explainable artificial intelligence technique called “counterfactual explanations” to analyze model performance. Counterfactuals are plausible samples on the desired side of a decision boundary 502 generated by perturbing a query sample 504. The graph 500 may be displayed onto the GUI 430 (see FIG. 4). This graph 500 depicts the feature space of a binary classifier with the two classes ‘A’ and ‘B’. Further, x is a query sample 504 and y and z are its two counterfactuals whose distance from the query is d_{XY} and d_{XZ}, respectively. A query sample 504 can have multiple counterfactuals and generally the closest counterfactual (here y) is desirable as it requires minimal perturbations to the query.

The AIMAM 406 may be configured to analyze, by utilizing/calling the analyzing module 426, how the average distance between the closest counterfactuals and the corresponding query samples (from the target data) changes over time. According to exemplary embodiments, a model's confidence in its prediction is reflected by the location of the data sample in the feature space. For example, if a model has high confidence in its prediction, then the corresponding data sample would be present far away from the decision boundary. Hence, if the average distance between query samples and the closest counterfactuals is reducing over time then it implies that the model is getting less confident in its predictions and data samples are getting closer to the decision boundary. This helps to understand how a model is performing over time without needing access to ground-truth labels.

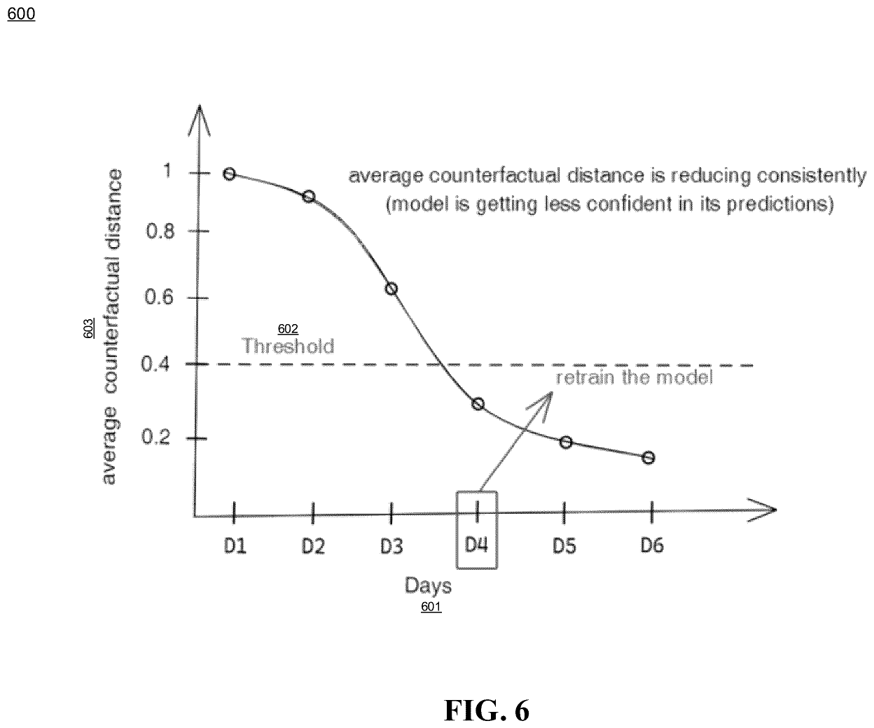

For example, FIG. 6 illustrates another exemplary graph 600 implemented by the platform, language, database, and cloud agnostic AIMAM 406 of FIG. 4 for illustrating how the counterfactual distance evolves over time as illustrated in FIG. 5 in identifying when to retrain an AI model in accordance with an exemplary embodiment.

According to exemplary embodiments, the AIMAM 406 implements the above methodology illustrated in FIG. 5 for a binary classification problem, but it can easily be extended to other settings (e.g., regression). Given a trained model M such that M(⋅):R^{d}→{0, 1}. Further, given a target dataset on the pₜₕ day Dₚ^{target}={Xₚ¹, Xₚ², . . . , Xₚ^{k}} where Xₚⁱ∈R^{d} represents the features of the iₜₕ target sample and k is the number of target samples received on the pₜₕ day. Assume dxₚⁱ is the distance between the ith target sample and the corresponding closest counterfactual. The computing module 418 of the AIMAM 406 computes

$$\frac{1}{k} {\sum }_{i = 1}^{k} {dx}_{p}^{i}$$

for the pₜₕ day.

According to exemplary embodiments, the AIMAM 406 implements the following algorithmic steps: i) given a model M and a set of target data samples on pₜₕ day Dₚ^{target}, compute δₚ the average distance between closest counterfactuals and corresponding target data samples on the pₜₕ day; ii) analyze how the distance metric (evolves over time, i.e., when p=1, 2, . . . , Nₜₕ day; iii) if the metric is getting smaller, then it indicates that the target data samples are getting close to the decision boundary (i.e., model is less confident) and vice versa; and iv) retrain the model if δₚ<ρ where ρ is a pre-defined threshold.

For example, referring back to FIGS. 4-6, according to exemplary embodiments, the receiving module 414 may be configured to receive from the database(s) 412 an AI model 412a and a set of target data samples 412b on a predefined time period (i.e., a predefined day) for identifying when to retrain the AI model 412a. The implementing module 416 may be configured to implement an artificial intelligence technique to generate a plurality of counterfactuals (i.e., y and z as illustrated in FIG. 5) and corresponding target data samples (i.e., x-query sample 504 as illustrated in FIG. 5) among the set of target data samples 412b for analyzing performance of the received AI model 412a.

According to exemplary embodiments, the computing module 418 may be configured to compute an average counterfactual distance between closest counterfactuals (i.e., y as illustrated in FIG. 5) and corresponding target data samples (i.e., x-query sample as illustrated in FIG. 5) on the predefined time period. The comparing module 420 may be configured to compare the average counterfactual distance to a predefined threshold value 602 as illustrated in FIG. 6. In this example as illustrated in FIG. 6, the threshold value 602 is set to 0.4 (average counterfactual distance), but the disclosure is not limited thereto. Any other configurable threshold value may be implemented, as desired by a particular use case, to identify when the AI model 412a needs to be retrained.

According to exemplary embodiments, the plurality of counterfactuals may be plausible samples (i.e., y and z as illustrated in FIG. 5) on a desired side of a decision boundary 502 generated by perturbing a query sample 504 (i.e., x as illustrated in FIG. 5).

According to exemplary embodiments, the predefined threshold value 602 as illustrated in FIG. 6 may be use case or dataset specific and may be used to identify whether retraining of the AI model is needed or not as illustrated in FIG. 5.

According to exemplary embodiments, the GUI 430 may be configured to display how the counterfactual distance evolves over time on a two-dimensional graph (i.e., graph 600 as illustrated in FIG. 6) wherein x-axis of the graph 600 represents days 601 (i.e., predefined time period) and y-axis of the graph represents average counterfactual distance 603.

According to exemplary embodiments, the identifying module 422 may be configured to identify that the AI model 412a needs to be retrained when output data from comparing by the comparing module 420 indicates that the average counterfactual distance is less than the predefined threshold value 602 (i.e., less than 0.4 in this example as illustrated in the graph 600 of FIG. 6). The retraining module 424 may be configured to automatically retrain the AI model 412a when it is determined that the average counterfactual distance is less than the predefined threshold value 602.

For example, as illustrated in FIG. 6, the graph 600 displayed on GUI 430 illustrates that the average counterfactual distance is reducing consistently indicating that the AI model 412a is getting less confident in its predictions. As illustrated in FIG. 6, the graph 600 shows that on day 1 (D1) the average counterfactual distance is about 1, on day 2 (D2) the average counterfactual distance is between 0.8 and 1, on day 3 (D3) the average counterfactual distance is about 0.6, on day 4 (D4) the average counterfactual distance is below 0.4 (the threshold value 602 in this example) indicating that the AI model 412a needs to be retrained as its predictions are getting less confident.

According to exemplary embodiments, the analyzing module 426 may be further configured to analyze how the average counterfactual distance evolves over time by monitoring the graph 600.

According to exemplary embodiments, the determining module 426 may be further configured to determine that the AI model 412a is less confident in outputting a prediction data based on determining that the target data samples are getting close to the decision boundary 502 over time (i.e., the average counterfactual distance is reducing consistently).

According to exemplary embodiments, the identifying module 422 may be configured to identify that the AI model 412a does not need to be retrained when output data from comparing by the comparing module 420 indicates that the average counterfactual distance is equal to or more than the predefined threshold value (i.e., 0.4 as illustrated in FIG. 6).

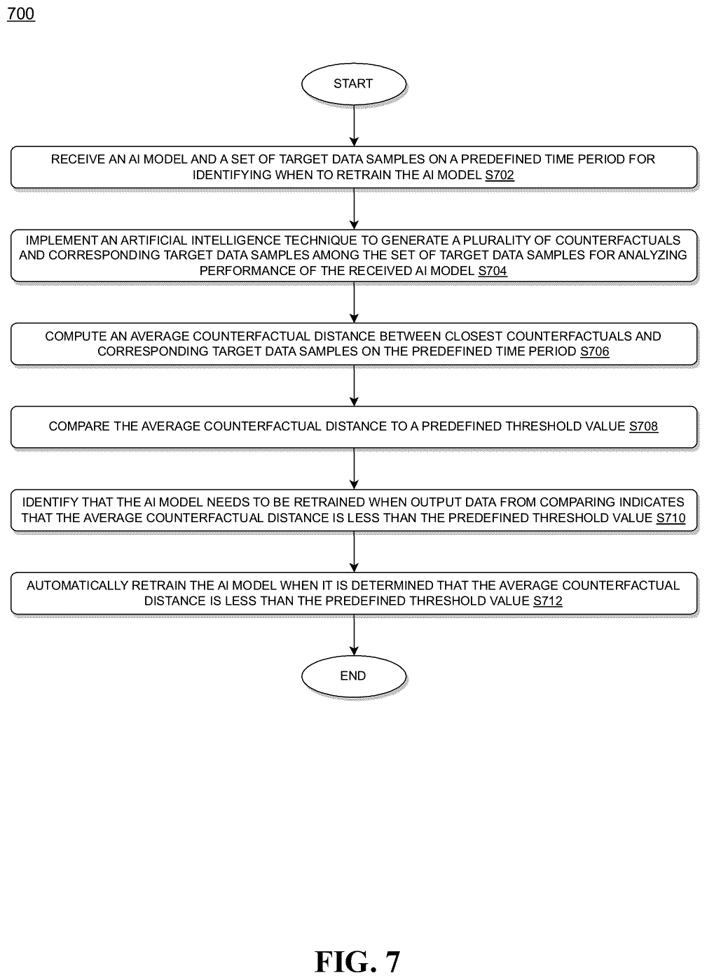

FIG. 7 illustrates an exemplary flow chart of a process 700 implemented by the platform, language, database, and cloud agnostic AIMAM 406 of FIG. 4 for systemically and dynamically identifying and determining when to retrain an AI model in accordance with an exemplary embodiment. It may be appreciated that the illustrated process 700 and associated steps may be performed in a different order, with illustrated steps omitted, with additional steps added, or with a combination of reordered, combined, omitted, or additional steps.

As illustrated in FIG. 7, at step S702, the process 700 may include receiving an AI model and a set of target data samples on a predefined time period for identifying when to retrain the AI model.

At step S704, the process 700 may include implementing an artificial intelligence technique to generate a plurality of counterfactuals and corresponding target data samples among the set of target data samples for analyzing performance of the received AI model.

At step S706, the process 700 may include computing an average counterfactual distance between closest counterfactuals and corresponding target data samples on the predefined time period.

At step S708, the process 700 may include comparing the average counterfactual distance to a predefined threshold value.

At step S710, the process 700 may include identifying that the AI model needs to be retrained when output data from comparing indicates that the average counterfactual distance is less than the predefined threshold value.

At step S712, the process 700 may include automatically retraining the AI model when it is determined that the average counterfactual distance is less than the predefined threshold value.

According to exemplary embodiments, in the process 700, the plurality of counterfactuals may be plausible samples on a desired side of a decision boundary generated by perturbing a query sample.

According to exemplary embodiments, in the process 700, the predefined threshold value may be use case or dataset specific and may be used to identify whether retraining of the AI model is needed or not.

According to exemplary embodiments, the process 700 may further include: displaying how the counterfactual distance evolves over time on a two-dimensional graph wherein x-axis of the graph represents days (i.e., time period) and y-axis of the graph represents average counterfactual distance.

According to exemplary embodiments, the process 700 may further include: analyzing how the average counterfactual distance evolves over time by monitoring the graph.

According to exemplary embodiments, the process 700 may further include: determining that the AI model is less confident in outputting a prediction data based on determining that the target data samples are getting close to the decision boundary over time (i.e., the average counterfactual distance is reducing consistently).

According to exemplary embodiments, the process 700 may further include: identifying that the AI model does not need to be retrained when output data from comparing indicates that the average counterfactual distance is equal to or more than the predefined threshold value.

According to exemplary embodiments, the AIMAD 402 may include a memory (e.g., a memory 106 as illustrated in FIG. 1) which may be a non-transitory computer readable medium that may be configured to store instructions for implementing a platform, language, database, and cloud agnostic AIMAM 406 for systemically and dynamically identifying and determining when to retrain an AI model as disclosed herein. The AIMAD 402 may also include a medium reader (e.g., a medium reader 112 as illustrated in FIG. 1) which may be configured to read any one or more sets of instructions, e.g., software, from any of the memories described herein. The instructions, when executed by a processor embedded within the AIMAM 406 or within the AIMAD 402, may be used to perform one or more of the methods and processes as described herein. In a particular embodiment, the instructions may reside completely, or at least partially, within the memory 106, the medium reader 112, and/or the processor 104 (see FIG. 1) during execution by the AIMAD 402.

According to exemplary embodiments, the instructions, when executed, may cause a processor embedded within the AIMAM 406 or the AIMAD 402 to perform the following: receiving an AI model and a set of target data samples on a predefined time period (i.e., a predefined day) for identifying when to retrain the AI model; implementing an artificial intelligence technique to generate a plurality of counterfactuals and corresponding target data samples among the set of target data samples for analyzing performance of the received AI model; computing an average counterfactual distance between closest counterfactuals and corresponding target data samples on the predefined time period; comparing the average counterfactual distance to a predefined threshold value; identifying that the AI model needs to be retrained when output data from comparing indicates that the average counterfactual distance is less than the predefined threshold value; and automatically retraining the AI model when it is determined that the average counterfactual distance is less than the predefined threshold value. According to exemplary embodiments, the processor may be the same or similar to the processor 104 as illustrated in FIG. 1 or the processor embedded within the AIMAD 202, AIMAD 302, AIMAD 402, and AIMAM 406 which is the same or similar to the processor 104.

According to exemplary embodiments, the plurality of counterfactuals may be plausible samples on a desired side of a decision boundary generated by perturbing a query sample and the predefined threshold value may be use case or dataset specific and may be used to identify whether retraining of the AI model is needed or not, wherein the instructions, when executed, may cause the processor 104 to further perform the following: displaying how the counterfactual distance evolves over time on a two-dimensional graph wherein x-axis of the graph represents days (i.e., predefined time period) and y-axis of the graph represents average counterfactual distance.

According to exemplary embodiments, the instructions, when executed, may cause the processor 104 to further perform the following: analyzing how the average counterfactual distance evolves over time by monitoring the graph.

According to exemplary embodiments, the instructions, when executed, may cause the processor 104 to further perform the following: determining that the AI model is less confident in outputting a prediction data based on determining that the target data samples are getting close to the decision boundary over time.

According to exemplary embodiments, the instructions, when executed, may cause the processor 104 to further perform the following: identifying that the AI model does not need to be retrained when output data from comparing indicates that the average counterfactual distance is equal to or more than the predefined threshold value.

According to exemplary embodiments as disclosed above in FIGS. 1-7, technical improvements effected by the instant disclosure may include a platform for implementing a platform, language, database, and cloud agnostic AI model analyzing module configured to systemically and dynamically identifying and determining when to retrain an AI model, but the disclosure is not limited thereto. For example, according to exemplary embodiments as disclosed above in FIGS. 1-7, technical improvements effected by the instant disclosure may include a platform for implementing a platform, language, database, and cloud agnostic AI model analyzing module configured to systemically and dynamically utilize/implement both input samples and how an AI model reacts to them, thereby by producing robust insights into how an AI model is performing, eventually leading to less false positives (i.e., training a model when the performance did not degrade enough) than the conventional approaches mentioned above, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for identifying when to retrain an artificial intelligence (AI) model by utilizing one or more processors along with allocated memory, the method comprising:
receiving an AI model and a set of target data samples on a predefined time period for identifying when to retrain the AI model;
implementing an artificial intelligence technique to generate a plurality of counterfactuals and corresponding target data samples among the set of target data samples for analyzing performance of the received AI model;
computing an average counterfactual distance between closest counterfactuals and corresponding target data samples on the predefined time period;
comparing the average counterfactual distance to a predefined threshold value;
identifying that the AI model needs to be retrained when output data from comparing indicates that the average counterfactual distance is less than the predefined threshold value; and
automatically retraining the AI model when it is determined that the average counterfactual distance is less than the predefined threshold value.

2. The method according to claim 1, wherein the plurality of counterfactuals are plausible samples on a desired side of a decision boundary generated by perturbing a query sample.

3. The method according to claim 2, wherein the predefined threshold value is use case or dataset specific and is used to identify whether retraining of the AI model is needed or not.

4. The method according to claim 2, further comprising:
displaying how counterfactual distance evolves over time on a two-dimensional graph wherein x-axis of the graph represents days and y-axis of the graph represents average counterfactual distance.

5. The method according to claim 4, further comprising:
analyzing how the average counterfactual distance evolves over time by monitoring the graph.

6. The method according to claim 5, further comprising:
determining that the AI model is less confident in outputting a prediction data based on determining that the target data samples are getting close to the decision boundary over time.

7. The method according to claim 1, further comprising:
identifying that the AI model does not need to be retrained when output data from comparing indicates that the average counterfactual distance is equal to or more than the predefined threshold value.

8. A system for identifying when to retrain an artificial intelligence (AI) model, the system comprising:
a processor; and
a memory operatively connected to the processor via a communication interface, the memory storing computer readable instructions, when executed, causes the processor to:
receive an AI model and a set of target data samples on a predefined time period for identifying when to retrain the AI model;
implement an artificial intelligence technique to generate a plurality of counterfactuals and corresponding target data samples among the set of target data samples for analyzing performance of the received AI model;
compute an average counterfactual distance between closest counterfactuals and corresponding target data samples on the predefined time period;
compare the average counterfactual distance to a predefined threshold value;
identify that the AI model needs to be retrained when output data from comparing indicates that the average counterfactual distance is less than the predefined threshold value; and
automatically retrain the AI model when it is determined that the average counterfactual distance is less than the predefined threshold value.

9. The system according to claim 8, wherein the plurality of counterfactuals are plausible samples on a desired side of a decision boundary generated by perturbing a query sample.

10. The system according to claim 9, wherein the predefined threshold value is use case or dataset specific and is used to identify whether retraining of the AI model is needed or not.

11. The system according to claim 9, wherein the processor is further configured to:
display how counterfactual distance evolves over time on a two-dimensional graph wherein x-axis of the graph represents days and y-axis of the graph represents average counterfactual distance.

12. The system according to claim 11, wherein the processor is further configured to:
analyze how the average counterfactual distance evolves over time by monitoring the graph.

13. The system according to claim 12, wherein the processor is further configured to:
determine that the AI model is less confident in outputting a prediction data based on determining that the target data samples are getting close to the decision boundary over time.

14. The system according to claim 8, wherein the processor is further configured to:
identify that the AI model does not need to be retrained when output data from comparing indicates that the average counterfactual distance is equal to or more than the predefined threshold value.

15. A non-transitory computer readable medium configured to store instructions for identifying when to retrain an artificial intelligence (AI) model, the instructions, when executed, cause a processor to perform the following:
receiving an AI model and a set of target data samples on a predefined time period for identifying when to retrain the AI model;
implementing an artificial intelligence technique to generate a plurality of counterfactuals and corresponding target data samples among the set of target data samples for analyzing performance of the received AI model;
computing an average counterfactual distance between closest counterfactuals and corresponding target data samples on the predefined time period;
comparing the average counterfactual distance to a predefined threshold value;
identifying that the AI model needs to be retrained when output data from comparing indicates that the average counterfactual distance is less than the predefined threshold value; and
automatically retraining the AI model when it is determined that the average counterfactual distance is less than the predefined threshold value.

16. The non-transitory computer readable medium according to claim 15, wherein the plurality of counterfactuals are plausible samples on a desired side of a decision boundary generated by perturbing a query sample.

17. The non-transitory computer readable medium according to claim 16, wherein the predefined threshold value is use case or dataset specific and is used to identify whether retraining of the AI model is needed or not.

18. The non-transitory computer readable medium according to claim 16, wherein the instructions, when executed, cause the processor to further perform the following:
displaying how counterfactual distance evolves over time on a two-dimensional graph wherein x-axis of the graph represents days and y-axis of the graph represents average counterfactual distance.

19. The non-transitory computer readable medium according to claim 18, wherein the instructions, when executed, cause the processor to further perform the following:
analyzing how the average counterfactual distance evolves over time by monitoring the graph; and
determining that the AI model is less confident in outputting a prediction data based on determining that the target data samples are getting close to the decision boundary over time.

20. The non-transitory computer readable medium according to claim 15, wherein the instructions, when executed, cause the processor to further perform the following:
identifying that the AI model does not need to be retrained when output data from comparing indicates that the average counterfactual distance is equal to or more than the predefined threshold value.
